(19) United States
(12) Patent Application Publication
(10) Pub. No.: US 2008/0084637 A1
(43) Pub. Date: Apr. 10, 2008

(54) Optimized design for a contact start-stop slider

(75) Inventors: Chao Yuan Chen, San Jose, CA (US); Michael Sullivan, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/543,525

(22) Filed: Oct. 4, 2006

(51) Int. Cl. G11B 5/60

(52) U.S. Cl. 360/235.8

(57) ABSTRACT

A head that flies relative to a disk of a hard disk drive. The head includes a substrate that has a pole tip, and an air bearing surface that has at least one rail and a central pad. The air bearing surface also has a plurality of contact dot that each makes contact with the disk at different skew angles. Providing contact at different skew angles insures that multiple dots do not make contact with the same track of the disk. This is particularly advantageous when the head is landed on the disk at the same skew angle.

### BACKGROUND OF THE INVENTION

1. Field of the Invention

The present invention relates to an air bearing surface of a head in a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure to create a subassembly commonly referred to as a head gimbal assembly (“HGA”). The HGA's are suspended from an actuator arm. The actuator arm has a voice coil motor that can move the heads across the surfaces of the disks.

In operation, each head is separated from a corresponding disk surface by an air bearing. The air bearing minimizes the mechanical wear between the head and the disk. The strength of the magnetic field is inversely proportional to the height of the air bearing. A smaller air bearing results in a stronger magnetic field on the disks, and vice versa.

The air bearing is created by an air flow induced by the rotation of the disks. When the hard disk drive is powered off the disks cease to rotate and the heads no longer fly. There are various approaches to parking the heads while the drive is powered down. One approach is to move the heads onto a ramp away from the surface of the disk. Another approach is to park the heads on the surface of the disk. This method is commonly referred to as contact start-stop (“CSS”).

When the disk drive is powered back up, the disks rotate and the heads fly once again. The disks are typically covered with a lubricant to reduce the amount of stiction when the head “takes-off” during a power up cycle.

FIG. 1 shows an air bearing surface of a head 1 in the prior art. The head 1 includes a pair of rails 2, a central pad 3 and a pole tip 4. The head 1 also includes a plurality of contact dots 5. The dots 5 have an outer layer of diamond (“DLC”) material.

The head may experience a head slapping event. Head slapping typically occurs when the hard drive is subjected to a shock which initially causes the head to move away from the disk and then slaps back down onto the surface of the disk. Head slapping may occur while the head is in the landing zone of the disk or during normal operation of the drive. The dots make contact with the disk surface during a head slapping event, and also when the head lands on the disk during a power down routine. The dots minimize the area in contact with the disk and reduce the effects of head slapping. The smaller surface area also reduces stiction and friction during head take-off.

As shown in FIG. 1, for a given landing zone skew angle, two of the dots may be aligned with the same track of the drive as well as the pole-tip area. The drive may power down and power up numerous times. This creates repeated contact between the head and the disk that may deplete the lubricant on the landing track of the disk. This wear is proportional to the number of dots in contact with the disk. Any dot aligned with the pole-tip area will accelerate head degradation since the corresponding disk wear is accelerated. It would be desirable to minimize the amount of contact between the dots and the same track of the disk.

### BRIEF SUMMARY OF THE INVENTION

A head that flies relative to a disk of a hard disk drive. The head includes a substrate that has a pole tip, and an air bearing surface that has at least one rail and a central pad. The air bearing surface also has a plurality of contact dots that each make contact with the disk at a different skew angle.

### BRIEF DESCRIPTION OF THE DRAWINGS

FIG. 1 is a top view of a head of the prior art;

FIG. 2 is a top view of an embodiment of a hard disk drive;

FIG. 3 is a top enlarged view of a head of the hard disk drive;

FIG. 4 is an electrical schematic of the hard disk drive.

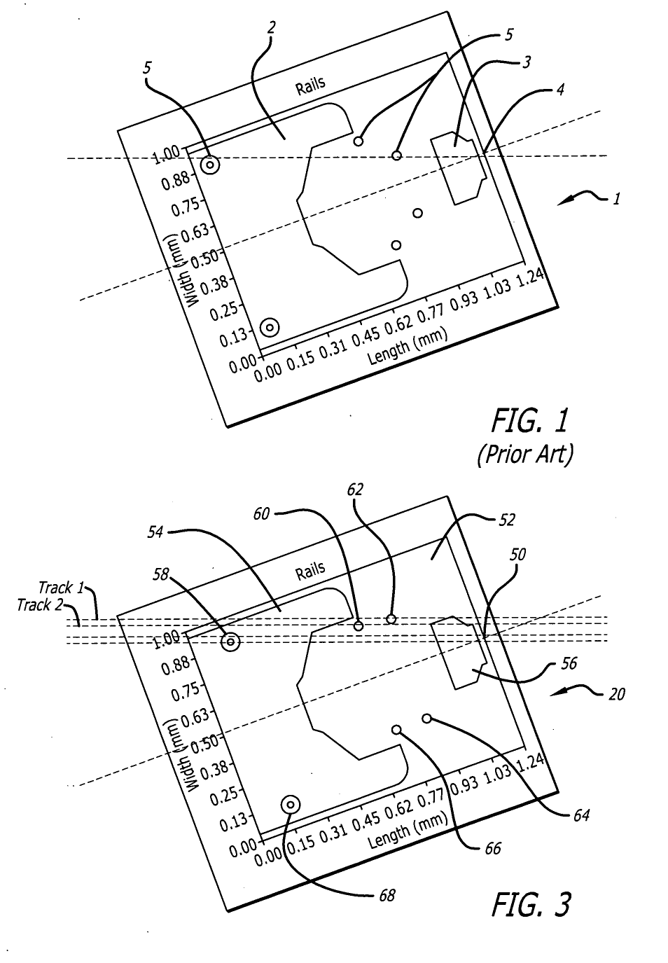

### DETAILED DESCRIPTION

Disclosed is a head that flies relative to a disk of a hard disk drive. The head includes a substrate that has a pole tip, and an air bearing surface that has at least one rail and a central pad. The air bearing surface also has a plurality of contact dots that each make contact with the disk at different skew angles. Providing contact at different skew angles insures that multiple dots do not make contact with the same track of the disk. This is particularly advantageous when the head is landed on the disk at the same skew angle.

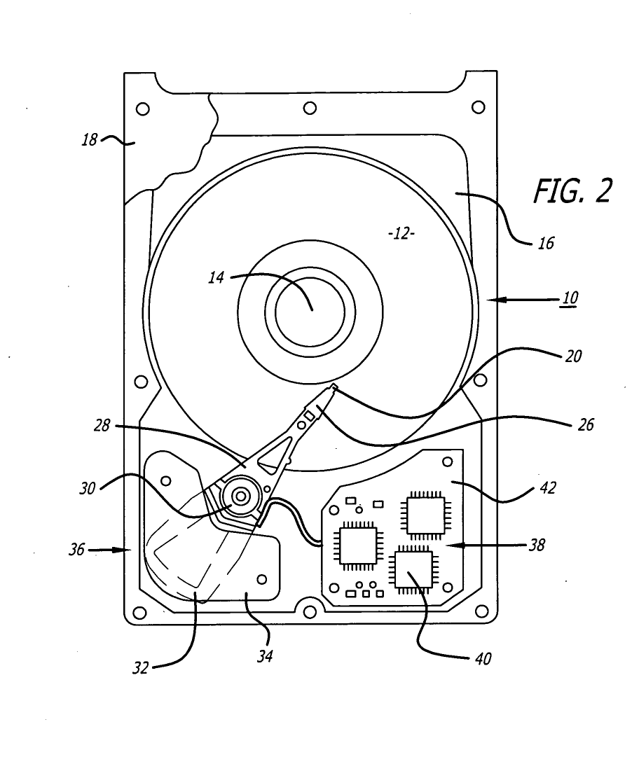

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12. The disk drive 10 may include a plurality of heads 20 located adjacent to the disks 12.

Each head 20 may be gimbal mounted to a flexure 26 as part of a head gimbal assembly (HGA). The flexure 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

FIG. 3 shows an embodiment of the head 20. The head 20 includes a pole tip 50 located on an air bearing surface 52. The pole tip 50 may include different read and write elements (not shown) for reading and writing data as is known in the art. The air bearing surface 52 may include a pair of rails 54 and a center pad 56 that together create a negative air bearing.

The air bearing surface 52 may include a plurality of contact dots 58, 60, 62, 64, 66 and 68. The dots 58, 60, 62, 64, 66 and 68 may have an outer layer of diamond (“DLC”) material that is relatively hard. The disk surfaces also typically have an outer layer of DLC. The similar DLC materials minimize scratching between the disk and heads.

The dots 58, 60, 62, 64, 66 and 68 are arranged so that different dots are aligned with the same skew angle but at different tracks of the disk when the head is parted on the landing zone of the disk. In this manner no more than one dot makes contact with any same track. This minimizes the damage to any single track during a head slapping event. Additionally, this approach also minimizes the amount of stiction wear during head take-off for any given track. During a stiction take-off period, the head makes contact with the disk primarily at the dot locations. If a dot is with the same disk wear track, the wear will be accelerated during the take-off period as well as touchdown period, increasing the amount of wear at the aligned track.

Each dot should preferably have a diameter no greater than 30 μm. The total surface area of the dots 58, 60, 62, 64, 66 and 68 is preferably less than 1 percent of the surface area of the air bearing surface 52. The above design situation will give the dot location flexibility to move around to avoid impacting the whole slider flying attitude.

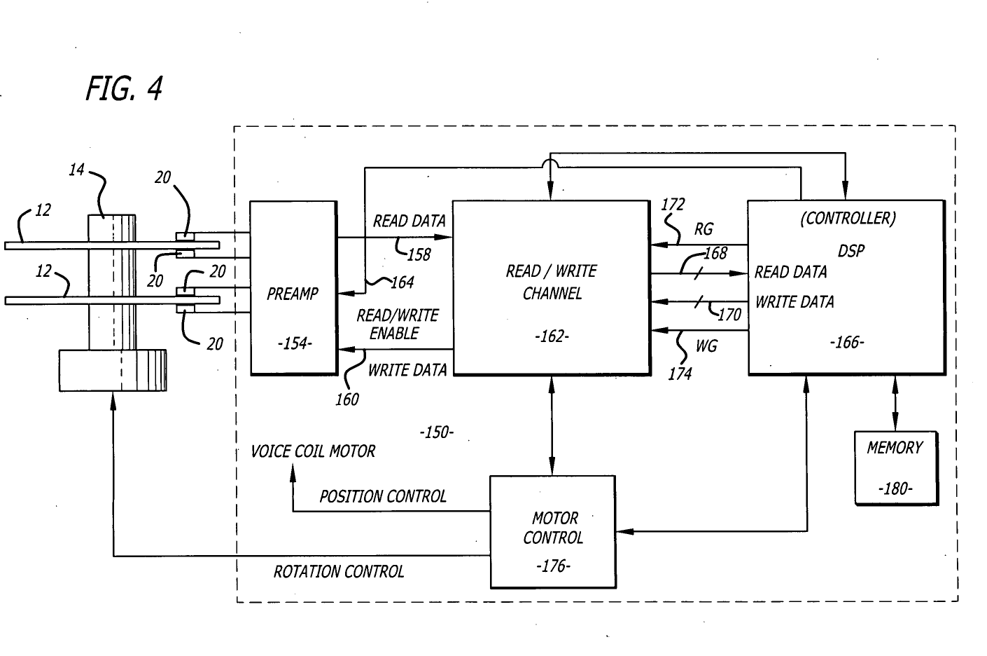

FIG. 4 shows an embodiment of a circuit 150 for the disk drive. The circuit 150 may include various electrical circuit for reading and writing data onto the disks 12. The circuits 150 may include a pre-amplifier circuit 154 that is coupled to a plurality of heads 20. There may be a head 20 for each disk surface. The pre-amplifier circuit 154 has a read data channel 158 and a write data channel 160 that are connected to a read/write channel circuit 162. The pre-amplifier 154 also has a read/write enable gate 164 connected to a controller 166. Data can be written onto the disks 12, or read from the disks 12 by enabling the read/write enable gate 164.

The read/write channel circuit 162 is connected to the controller 166 through read and write channels 168 and 170, respectively, and read and write gates 172 and 174, respectively. The read gate 172 is enabled when data is to be read from the disks 12. The write gate 174 is to be enabled when writing data to the disks 12. The controller 166 may be a digital signal processor that operates in accordance with a software routine, including a routine(s) to write and read data from the disks 12. The read/write channel circuit 162 and controller 166 may also be connected to a motor control circuit 176 which controls a voice coil motor (not shown) and the spindle motor. The voice coil motor can move the heads 20 relative to the disks 12. The controller 166 may be connected to a non-volatile memory device 180. By way of example, the device 180 may be a read-only memory (“ROM”) that contains instructions that are read by the controller 166.

The circuit 150 may cause the heads 20 to move to a landing zone of the disk during a power down routine. The contact dots of the head are arranged so that no two dots are in contact with the same disk track while the head is landed or aligned with the pole-tip area. The circuit may also rotate the disks and cause the heads to take-off during a power up routine. The arrangement of contact dots minimizes the stiction wear on any given track between the head and disk during the power up routine.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A head of a hard disk drive that has a disk comprising:
a substrate that has a pole tip and an air bearing surface that has at least one rail, a central pad, and a plurality of contact dots, each contact dot makes contact with the disk at a different skew angle.

2. The head of claim 1, wherein there are 6 contact dots.

3. The head of claim 1, wherein said contact dots each have an outer layer of diamond material.

4. The head of claim 1, wherein each contact dot has a diameter no greater than 30 μm.

5. The head of claim 1, wherein said contact dots collectively have an area less than 1 percent of an area of said air bearing surface.

6. A head of a hard disk drive that comprising:
a substrate that has a pole tip and an air bearing surface that has at least one rail, a central pad, and contact means for making contact with the disk at different skew angles.

7. The head of claim 6, wherein said contact means includes a plurality of contact dots.

8. The head of claim 7, wherein there are 6 contact dots.

9. The head of claim 7, wherein said contact dots each have an outer layer of diamond material.

10. The head of claim 7, wherein each contact dot has a diameter no greater than 30 μm.

11. The head of claim 3, wherein said contact dots collectively have an area less than 1 percent of an area of said air bearing surface.

12. A hard disk drive, comprising:
a disk;
a spindle motor coupled to said disk;
an actuator arm; and,
a head coupled to said actuator arm and said disk, said head includes a substrate that has a pole tip and an air bearing surface that has at least one rail, a central pad, and a plurality of contact dots, each contact dot makes contact with said disk at a different skew angle.

13. The disk drive of claim 12, wherein there are 6 contact dots.

14. The disk drive of claim 12, wherein said contact dots each have an outer layer of diamond material.

15. The disk drive of claim 12, wherein each contact dot has a diameter no greater than 30 μm.

16. The disk drive of claim 12, wherein said contact dots collectively have an area less than 1 percent of an area of said air bearing surface.

17. A method for landing a head onto a disk of a hard disk drive, comprising:
moving a head over a portion of a disk; and,
landing the head onto the disk so that a plurality of contact points make contact with the disk at different skew angles.
